(19) United States
(12) Patent Application Publication
(10) Pub. No.: US 2019/0122141 A1
(43) Pub. Date: Apr. 25, 2019

(54) FAST HYPERPARAMETER SEARCH FOR MACHINE-LEARNING PROGRAM

(71) Applicant: Microsoft Technology Licensing, LLC, Redmond, WA (US)

(72) Inventors: Yi Zhen, San Jose, CA (US); Florian Raudies, Mountain View, CA (US); Bee-Chung Chen, San Jose, CA (US); Yiming Ma, Menlo Park, CA (US)

(21) Appl. No.: 15/790,816

(22) Filed: Oct. 23, 2017

(51) Int. Cl. G06N 99/00; G06N 5/02; G06N 7/00

(52) U.S. Cl. CPC G06N 99/005; G06N 7/00; G06N 5/022

(57) ABSTRACT

Methods, systems, and computer programs are presented for calculating a hyperparameter value set for training a machine-learning program (MLP). One method includes an operation for identifying a model for the MLP that comprises hyperparameter value sets to be tested based on a dataset that has performance data for features of the MLP. The method further includes operations for breaking the dataset into fragments for evaluating the model with a graphics processing unit (GPU) and for loading the cores of the GPU with the model and a respective hyperparameter value set. Each fragment of the dataset is streamed to a GPU memory, and the cores of the GPU evaluate, in parallel, the fragment based on the model and the respective hyperparameter value set. Further, the method includes operations for determining, storing, and presenting the best hyperparameter value set for the MLP.

### TECHNICAL FIELD

The subject matter disclosed herein generally relates to methods, systems, and programs for training a machine-learning program and, more particularly, methods, systems, and computer programs for finding the best hyperparameters for the machine-learning program.

### BACKGROUND

Deep learning has been widely applied to image understanding, speech recognition, natural language translation, games, and many other prediction and classification problems. However, machine learning remains a hard problem when implementing existing algorithms and models to fit into a given application.

Training and testing deep models remains challenging not only because a huge amount of data needs to be consumed before a good model is trained, but also because hyperparameters (e.g., the parameters used to configure a machine-learning model) are critical and hard to find for model training. Often, there are many hyperparameters that must be optimized. For instance, hyperparameters may include the number of hidden layers, the number of hidden nodes in each layer, the learning rate with various adaptation schemes for the learning rate, the regularization parameters, types of nonlinear activation functions, and whether to use dropout. Finding the correct (or the best) set of hyperparameters is a very time-consuming task that requires a large amount of computer resources.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments, including a social networking server.

FIG. 2 is a screenshot of a user feed that includes items in different categories, according to some example embodiments.

FIG. 3 illustrates the training and use of a machine-learning program, according to some example embodiments.

FIG. 4 illustrates a method for selecting hyperparameters, according to some example embodiments.

FIG. 5 illustrates the model and the dataset for the machine-learning program, according to some example embodiments.

FIG. 6 is an architecture for model training, according to some example embodiments.

FIG. 7 illustrates the model program executing on a graphics processing unit (GPU) core, according to some example embodiments.

FIG. 8 illustrates the task distribution by the modeling manager, according to some example embodiments.

FIG. 9 is a flowchart of a method, according to some example embodiments, for searching a hyperparameter value set for training a machine-learning program.

FIG. 10 shows some example embodiments of test experiments.

FIG. 11 is a block diagram illustrating a representative software architecture, which may be used in conjunction with various hardware architectures herein described.

FIG. 12 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

Example methods, systems, and computer programs are directed to searching a hyperparameter value set for training a machine-learning program. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Existing approaches for machine-learning training do not address the high computation costs required for hyperparameter search in large models, including having a great number of hyperparameters trained with large amounts of data, which require long training periods.

Finding the right model configuration for a specific application, requires exploring the model performance by executing multiple exploratory runs on many different hyperparameter combinations. Each run is considered as a single model with a single hyperparameter configuration, and the runs may be structured sequentially or in parallel.

However, before drawing conclusions on the potential hyperparameters, a large number of hyperparameter configurations, which could be in the thousands, need to be tested. This exploratory process takes a long time if run sequentially or when using a parallel infrastructure with only a small number of runs executing at the same time (e.g., using less than 20 machines).

Embodiments provide a system for quickly exploring a large number of models and hyperparameters utilizing GPUs. Each core in the GPU is configured to run a model with a certain hyperparameter set, and the cores share the model program and the dataset, or a subset thereof, stored in the memory of the GPU. When dealing with large datasets, the model processes dataset fragments sequentially. A modeling manager transfers each fragment of the dataset to the memory of the GPU and activates the cores to process each fragment of the dataset in parallel. Since the GPUs may have hundreds of cores, it is possible to quickly explore a large number of hyperparameter sets much faster than when using the handful of cores that a Central Processing Unit (CPU) may have. CPU-based solutions may only access a limited number of cores and are not able to provide a high degree of parallelization for the computations. Hyperparameter search is an operation very suited to parallelization, and the CPU-based solutions may not fully exploit this parallelism.

The advantage of the GPU approach is that, for a model (e.g., with a number of hyperparameter sets in the range of a million), one GPU chip can test thousands of configurations in parallel.

In one embodiment, a method is provided. The method includes an operation for identifying a model for a machine-learning program The model comprises a plurality of hyperparameter value sets to be tested based on a dataset, with the dataset having performance data for a plurality of features identified for the machine-learning program. The method further includes operations for breaking the dataset into a plurality of fragments for evaluating the model with a GPU and for loading a plurality of cores of the GPU with the model and a respective hyperparameter value set. For each fragment from the plurality of fragments of the dataset, the fragment of the dataset is streamed to a GPU memory, and the plurality of cores of the GPU evaluate, in parallel, the fragment of the dataset based on the model and the respective hyperparameter value set associated with each core of the GPU. Further, the method includes operations for determining a best hyperparameter value set, from the plurality of hyperparameter value sets, for the machine-learning program, and for storing and causing presentation of the best hyperparameter value set.

In another embodiment, a system includes a memory comprising instructions, a GPU having a plurality of GPU cores and a GPU memory, and one or more computer processors. The instructions, when executed by the one or more computer processors, cause the one or more computer processors to perform operations comprising: identifying a model for a machine-learning program, with the model comprising a plurality of hyperparameter value sets to be tested based on a dataset, the dataset having performance data for a plurality of features identified for the machine-learning program; breaking the dataset into a plurality of fragments for evaluating the model with the GPU; loading the plurality of cores of the GPU with the model and a respective hyperparameter value set; for each fragment from the plurality of fragments of the dataset, streaming the fragment of the dataset to the GPU memory, wherein the plurality of cores of the GPU evaluate, in parallel, the fragment of the dataset based on the model and the respective hyperparameter value set associated with each core of the GPU; determining a best hyperparameter value set, from the plurality of hyperparameter value sets, for the machine-learning program; and storing and causing presentation of the best hyperparameter value set.

In yet another embodiment, a non-transitory machine-readable storage medium including instructions that, when executed by a machine, cause the machine to perform operations comprising: identifying a model for a machine-learning program, with the model comprising a plurality of hyperparameter value sets to be tested based on a dataset, the dataset having performance data for a plurality of features identified for the machine-learning program; breaking the dataset into a plurality of fragments for evaluating the model with a GPU; loading a plurality of cores of the GPU with the model and a respective hyperparameter value set; for each fragment from the plurality of fragments of the dataset, streaming the fragment of the dataset to a GPU memory and evaluating, in parallel by the plurality of cores of the GPU, the fragment of the dataset based on the model and the respective hyperparameter value set associated with each core of the GPU; determining a best hyperparameter value set, from the plurality of hyperparameter value sets, for the machine-learning program; and storing and causing presentation of the best hyperparameter value set.

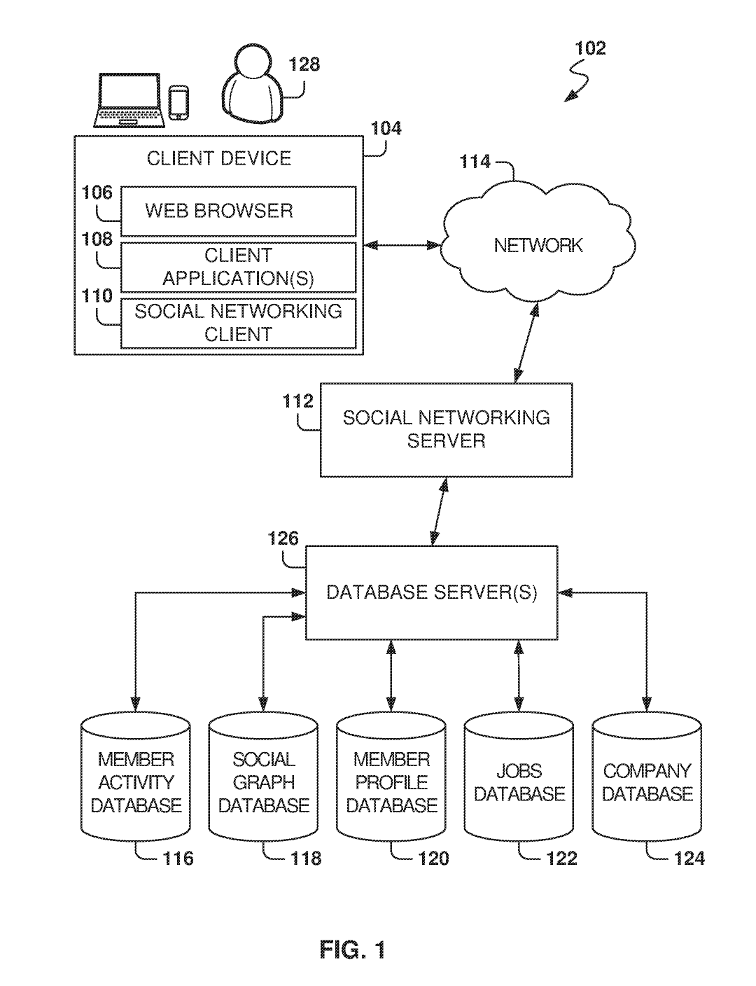

FIG. 1 is a block diagram illustrating a networked system, according to some example embodiments, including a social networking server 112, illustrating an example embodiment of a high-level client-server-based network architecture 102. The social networking server 112 provides server-side functionality via a network 114 (e.g., the Internet or a wide area network (WAN)) to one or more client devices 104. FIG. 1 illustrates, for example, a web browser 106, client application(s) 108, and a social networking client 110 executing on a client device 104. The social networking server 112 is further communicatively coupled with one or more database servers 126 that provide access to one or more databases 116-124.

The client device 104 may comprise, but is not limited to, a mobile phone, a desktop computer, a laptop, a portable digital assistant (PDA), a smart phone, a tablet, a netbook, a multi-processor system, a microprocessor-based or programmable consumer electronic system, or any other communication device that a user 128 may utilize to access the social networking server 112. In some embodiments, the client device 104 may comprise a display module (not shown) to display information (e.g., in the form of user interfaces). In further embodiments, the client device 104 may comprise one or more of touch screens, accelerometers, gyroscopes, cameras, microphones, global positioning system (GPS) devices, and so forth.

In one embodiment, the social networking server 112 is a network-based appliance that responds to initialization requests or search queries from the client device 104. One or more users 128 may be a person, a machine, or other means of interacting with the client device 104. In various embodiments, the user 128 is not part of the network architecture 102, but may interact with the network architecture 102 via the client device 104 or another means. For example, one or more portions of the network 114 may be an ad hoc network, an intranet, an extranet, a virtual private network (VPN), a local area network (LAN), a wireless LAN (WLAN), a WAN, a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The client device 104 may include one or more applications (also referred to as “apps”) such as, but not limited to, the web browser 106, the social networking client 110, and other client applications 108, such as a messaging application, an electronic mail (email) application, a news application, and the like. In some embodiments, if the social networking client 110 is present in the client device 104, then the social networking client 110 is configured to locally provide the user interface for the application and to communicate with the social networking server 112, on an as-needed basis, for data and/or processing capabilities not locally available (e.g., to access a member profile, to authenticate a user 128, to identify or locate other connected members, etc.). Conversely, if the social networking client 110 is not included in the client device 104, the client device 104 may use the web browser 106 to access the social networking server 112.

Further, while the client-server-based network architecture 102 is described with reference to a client-server architecture, the present subject matter is of course not limited to such an architecture, and could equally well find application in a distributed, or peer-to-peer, architecture system, for example.

In addition to the client device 104, the social networking server 112 communicates with the one or more database server(s) 126 and database(s) 116-124. In one example embodiment, the social networking server 112 is communicatively coupled to a member activity database 116, a social graph database 118, a member profile database 120, a jobs database 122, and a company database 124. The databases 116-124 may be implemented as one or more types of databases including, but not limited to, a hierarchical database, a relational database, an object-oriented database, one or more flat files, or combinations thereof.

The member profile database 120 stores member profile information about members who have registered with the social networking server 112. With regard to the member profile database 120, the member may include an individual person or an organization, such as a company, a corporation, a nonprofit organization, an educational institution, or other such organizations.

Consistent with some example embodiments, when a user initially registers to become a member of the social networking service provided by the social networking server 112, the user is prompted to provide some personal information, such as name, age (e.g., birth date), gender, interests, contact information, home town, address, spouse's and/or family members' names, educational background (e.g., schools, majors, matriculation and/or graduation dates, etc.), employment history, professional industry (also referred to herein simply as “industry”), skills, professional organizations, and so on. This information is stored, for example, in the member profile database 120. Similarly, when a representative of an organization initially registers the organization with the social networking service provided by the social networking server 112, the representative may be prompted to provide certain information about the organization, such as a company industry. This information may be stored, for example, in the member profile database 120. In some embodiments, the profile data may be processed (e.g., in the background or offline) to generate various derived profile data. For example, if a member has provided information about various job titles that the member has held with the same company or different companies, and for how long, this information may be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

In some example embodiments, the company database 124 stores information regarding companies in the member's profile. A company may also be a member, but some companies may not be members of the social network although sonic of the employees of the company may be members of the social network. The company database 124 includes company information, such as name, industry, contact information, website, address, location, geographic scope, and the like.

As users interact with the social networking service provided by the social networking server 112, the social networking server 112 is configured to monitor these interactions. Examples of interactions include, but are not limited to, commenting on posts entered by other members, viewing member profiles, editing or viewing a member's own profile, sharing content outside of the social networking service (e.g., an article provided by an entity other than the social networking server 112), updating a current status, posting content for other members to view and comment on, posting job suggestions for the members, searching job posts, and other such interactions. In one embodiment, records of these interactions are stored in the member activity database 116, which associates interactions made by a member with his or her member profile stored in the member profile database 120. In one example embodiment, the member activity database 116 includes the posts created by the users of the social networking service for presentation on user feeds.

The jobs database 122 includes job postings offered by companies in the company database 124. Each job posting includes job-related information such as any combination of employer, job title, job description, requirements for the job, salary and benefits, geographic location, one or more job skills required, day the job was posted, relocation benefits, and the like.

In one embodiment, the social networking server 112 communicates with the various databases 116-124 through the one or more database server(s) 126. In this regard, the database server(s) 126 provide one or more interfaces and/or services for providing content to, modifying content in, removing content from, or otherwise interacting with the databases 116-124. For example, and without limitation, such interfaces and/or services may include one or more Application Programming Interfaces (APIs), one or more services provided via a Service-Oriented Architecture (SOA), one or more services provided via a Representational State Transfer (REST)-Oriented Architecture (ROA), or combinations thereof. In an alternative embodiment, the social networking server 112 communicates with the databases 116-124 and includes a database client, engine, and/or module, for providing data to, modifying data stored within, and/or retrieving data from the one or more databases 116-124.

While the database server(s) 126 is illustrated as a single block, one of ordinary skill in the art will recognize that the database server(s) 126 may include one or more such servers. For example, the database server(s) 126 may include, but are not limited to, a Microsoft® Exchange Server, a Microsoft® Sharepoint® Server, a Lightweight Directory Access Protocol (LDAP) server, a MySQL database server, or any other server configured to provide access to one or more of the databases 116-124, or combinations thereof. Accordingly, and in one embodiment, the database server(s) 126 implemented by the social networking service are further configured to communicate with the social networking server 112.

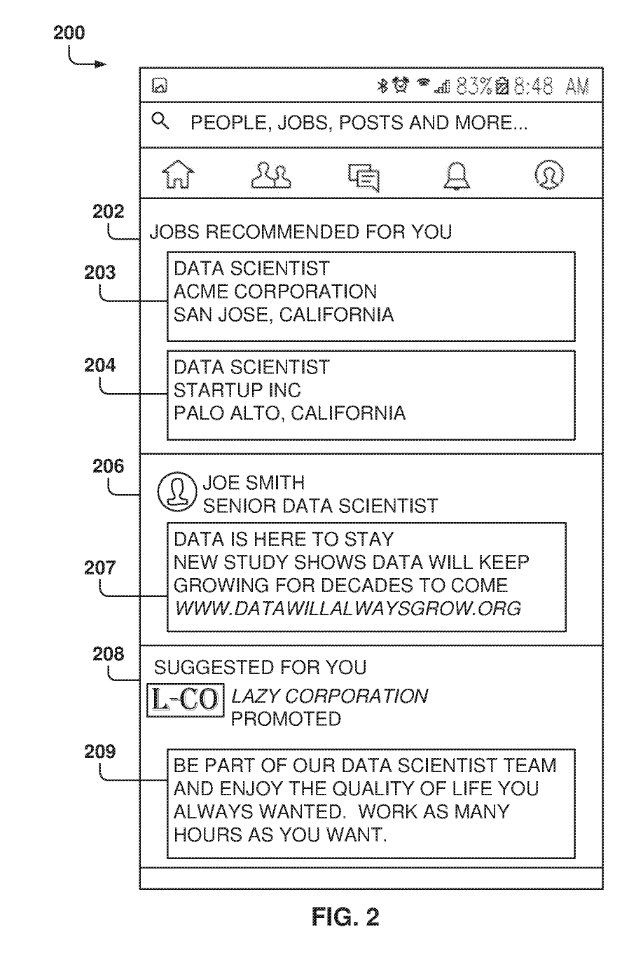

FIG. 2 is a screenshot of a user feed 200 that includes items in different categories, according to some example embodiments. In the example embodiment of FIG. 2, the user feed 200 includes different categories, such as job recommendations 202, user posts 206, and sponsored items 208, and other embodiments may include additional categories.

In one example embodiment, the social network user interface provides the job recommendations 202 (e.g., job posts 203 and 204) that match the job interests of the user and that are presented with a specific job search request from the user.

The user posts 206 include items 207 posted by users of the social network (e.g., items posted by connections of the user), and may be comments made on the social network, pointers to interesting articles or webpages, etc.

The sponsored items 208 are items 209 placed by sponsors of the social network, which pay a fee for posting those items on user feeds, and may include advertisements or links to webpages that the sponsors want to promote.

Although the categories are shown as separated within the user feed 200, the items from the different categories may be intermixed, and not just be presented as a block. Thus, the user feed 200 may include a large number of items from each of the categories, and the social network decides the order in which these items are presented to the user based on the desired utilities.

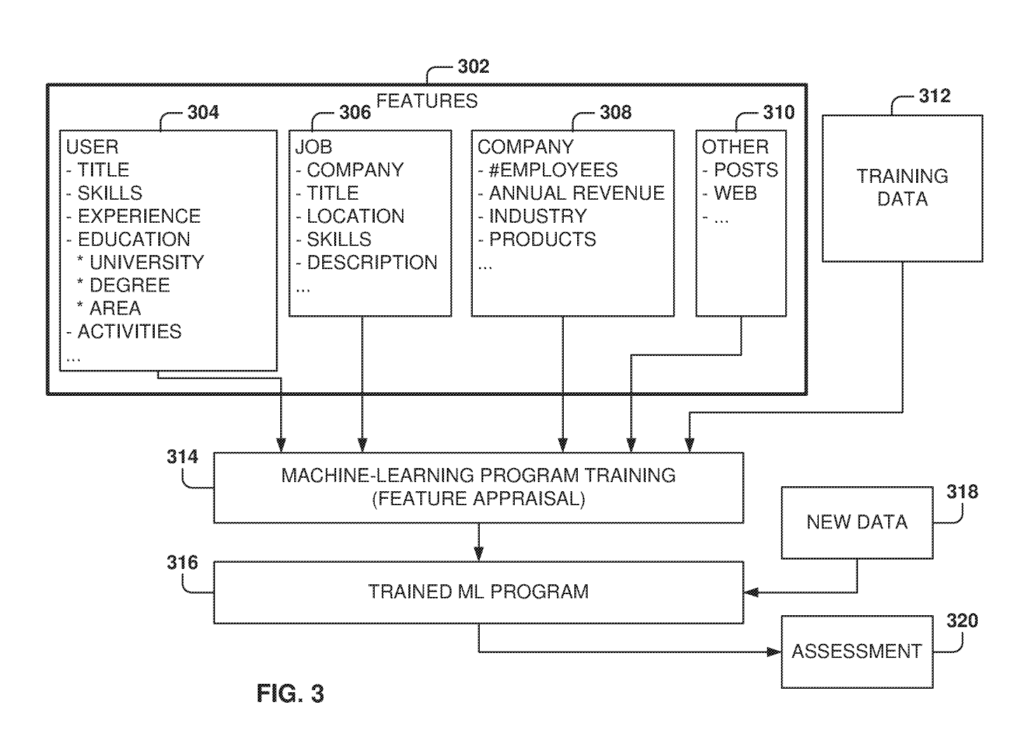

FIG. 3 illustrates the training and use of a machine-learning program, according to some example embodiments. In some example embodiments, machine-learning programs (MLP), also referred to as machine-learning algorithms or tools, are utilized to perform operations associated with searches, such as job searches.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 312 in order to make data-driven predictions or decisions expressed as outputs or assessments 320. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). In some embodiments, example machine-learning algorithms provide a job affinity score (e.g., a number from 1 to 100) to qualify each job as a match for the user (e.g., calculating the job affinity score). The machine-learning algorithms utilize the training data 312 to find correlations among identified features 302 that affect the outcome.

The machine-learning algorithms utilize features for analyzing the data to generate assessments 320. A feature 302 is an individual measurable property of a phenomenon being observed. The concept of feature is related to that of an explanatory variable used in statistical techniques such as linear regression. Choosing informative, discriminating, and independent features is important for effective operation of the MLP in pattern recognition, classification, and regression. Features may be of different types, such as numeric, strings, and graphs.

In one example embodiment, the features 302 may be of different types and may include one or more of user features 304, job features 306, company features 308, and other features 310. The user features 304 may include one or more of the data in the user profile 304 such as title, skills, endorsements, experience, education, and the like. The job features 306 may include any data related to the job, and the company features 308 may include any data related to the company. In some example embodiments, other features 310 may be included, such as post data, message data, web data, and the like.

The machine-learning algorithms utilize the training data 312 to find correlations among the identified features 302 that affect the outcome or assessment 320. In some example embodiments, the training data 312 includes known data for one or more identified features 302 and one or more outcomes, such as jobs searched by users, job suggestions selected for reviews, users changing companies, users adding social connections, users' activities online, and the like.

With the training data 312 and the identified features 302, the machine-learning tool is trained at operation 314. The machine-learning tool appraises the value of the features 302 as they correlate to the training data 312. The result of the training is the trained machine-learning program 316.

When the machine-learning program 316 is used to perform an assessment, new data 318 is provided as an input to the trained machine-learning program 316, and the machine-learning program 316 generates the assessment 320 as output. For example, when a user performs a job search, a machine-learning program, trained with social network data, utilizes the user data and the job data, from the jobs in the database, to search for jobs that match the user's profile and activity.

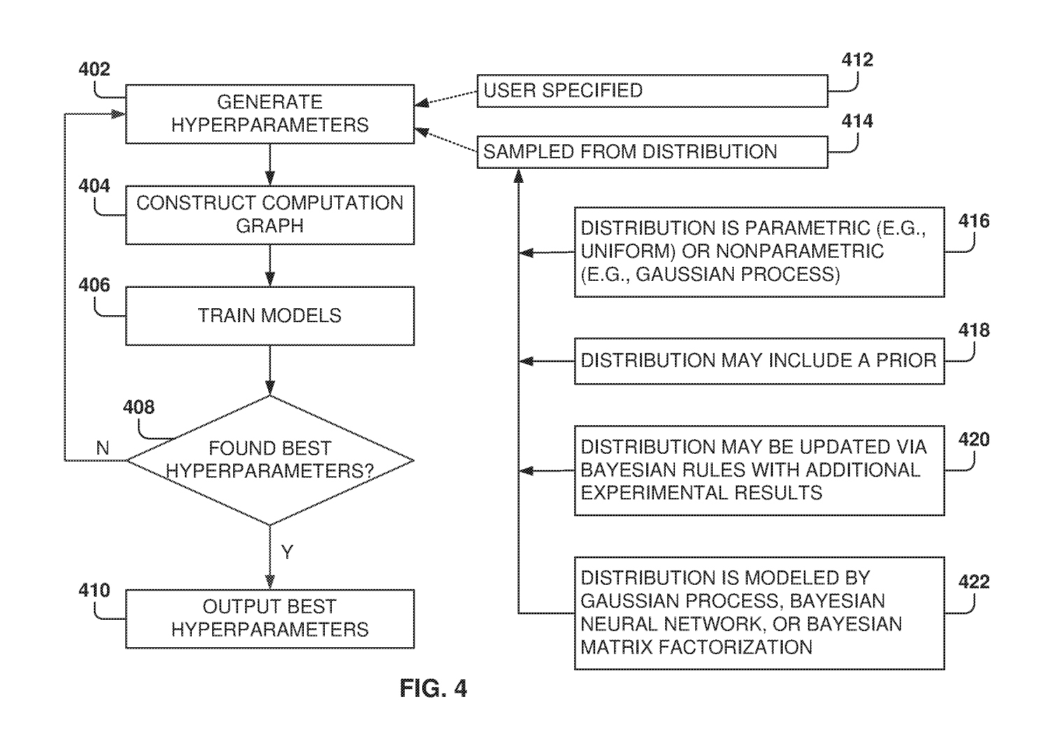

FIG. 4 illustrates a method for selecting hyperparameters, according to some example embodiments. While the various operations in this flowchart are presented and described sequentially, one of ordinary skill will appreciate that some or all of the operations may be executed in a different order, be combined or omitted, or be executed in parallel.

Effective machine-learning design requires tuning the hyperparameters for the models, trying out many different models, and exploring several feature representations of the data, which is why machine-learning training requires a large amount of computing resources. Embodiments provide a framework for faster hyperparameter selection utilizing GPUs.

At operation 402, the hyperparameters for deep learning models are generated. The hyperparameters may be generated in multiple ways, such as being specified by the user 412 or sampled from a distribution 414. The distribution is often unknown and needs to be inferred or learned from the available data. The hyperparameters sampled from a distribution 414 may be generated in multiple ways, such as from a parametric distribution 416 (e.g., a uniform distribution) or nonparametric (such as Gaussian process.) The hyperparameter distribution can include a prior 418, the hyperparameter distribution may be updated 420 via Bayesian rules when additional experimental results are provided, or the hyperparameter distribution may be modeled by a Gaussian processes, a Bayesian neural network, or a Bayesian matrix factorization.

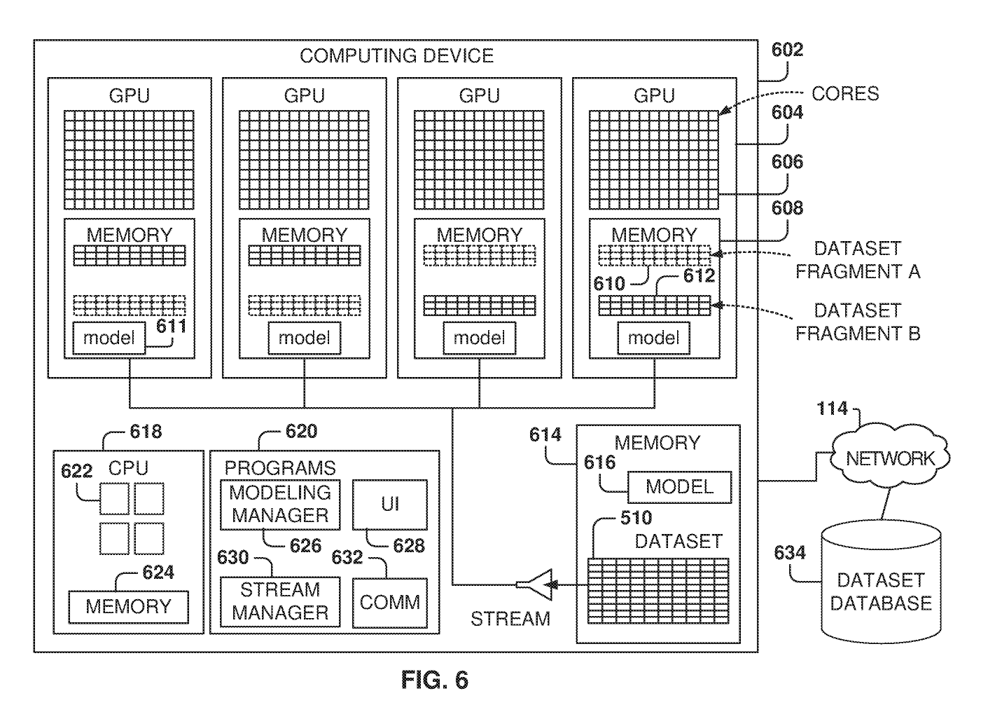

At operation 404, the computation graph is constructed for a set of given hyperparameter configurations. In some example embodiments, each hyperparameter configuration is associated with one sub-model, and the sub-models are fed the same inputs (as discussed in more detail below with reference to FIG. 6), which greatly reduces the throughput required for data loading.

At operation 406, the models are trained by running experiments for each computation graph and different hyperparameter configurations. The different hyperparameter configurations are then compared to determine the best configuration or if convergence towards a solution has been found.

The experiments include model training and validation, which includes determining the accuracy of the model for predicting outcomes. Further, the experiments may be run on a variety of devices, such as devices having CPUs and/or GPUs. However, the experiments run on GPUs, or GPU clusters, are much faster than experiments run on CPUs because training and validation of the sub-models are highly parallelizable.

In some example embodiments, a modeling manager decides if training or validation should be terminated before a maximum number of steps. The early termination may be due to the network training process diverging from target, and the early termination saves the use of computational resources on unpromising directions. Further, the modeling manager schedules the training and validation operations for the sub-models based on available computational resources. Further yet, a stream manager acts as a data allocator that feeds data to the sub-models.

At operation 408, a check is made to determine if the best hyperparameters have been found. In some example embodiments, it is determined that the best parameters have been found when the testing shows convergence of the model towards one or more sets of values with high performance for predicting scores.

There are different approaches for finding viable hyperparameter configurations. For each of the configurations, the model is trained with hyperparameters until the training procedure converges and a working model is found. Afterwards, if the hyperparameters are fixed, the training process with the given dataset is performed to train the model with the found hyperparameters.

In some example embodiments, there is a validation dataset used to assess the performance of the different models and hyperparameter configurations. This means that the performance of the hyperparameters is validated with the validation dataset.

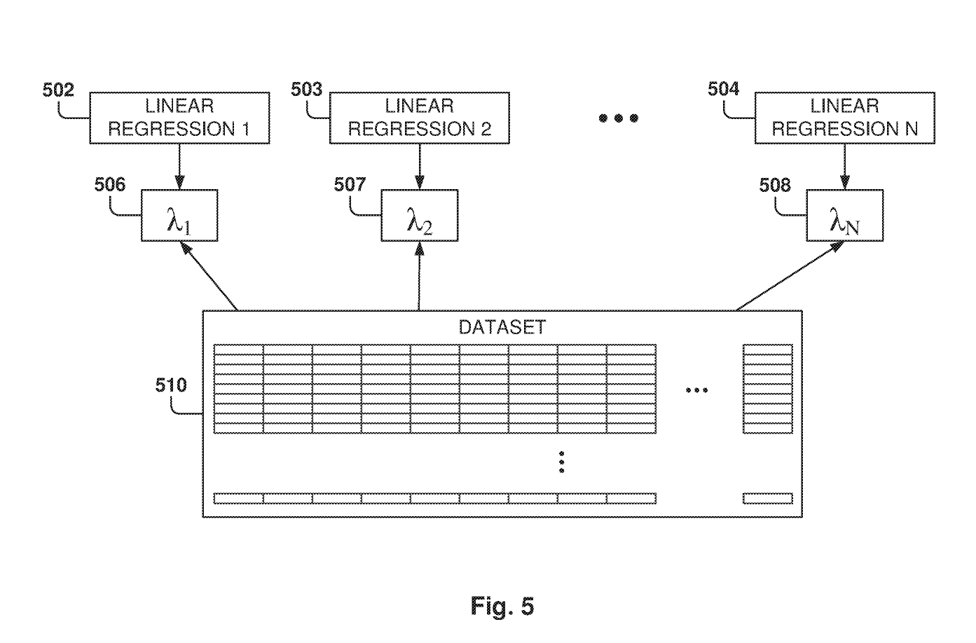

For example, in some example embodiments, a logistic regression with a single layer network and a single tuning parameter is evaluated, as described in more detail below with reference to FIG. 5. For testing, a range of values for the tuning parameters is identified (e.g., from 10 to 500) and sampling of the range is done to test the models. For example, values may be spaced out by tens, which would mean testing for 10, 20, 30, and so forth. As additional data is gathered, the results are evaluated to generate a convergence towards an optimal value. For example, the best values may be found between 120 and 140, and new tests may be run with increments of one, such as 120, 121, 122, and so forth. A new range may be found between 131 and 133, so new samples may be done every 0.1. The process is repeated until the best hyperparameter set is found.

In other models, a network of hyperparameters are used, so the sampling is performed in a multidimensional space, which means that the sampling possibilities grow geometrically with the number of hyperparameters. It is noted that, in some embodiments, the best models are chosen based on user-specified hyperparameter metrics.

In some example embodiments, after an initial exploration stage, a region of hyperparameters is identified as having high potential. Since models stored in GPU memory are in the same local process space, it is much easier to change the settings of hyperparameter tuning jobs to potentially more promising settings. The use of the GPU architecture makes changing the parameter settings much more flexible than when using a CPU cluster, because, among other things, the CPU cluster requires inter-machine communications.

The embodiments presented herein reduce the cost of validating one model with a set of hyperparameters. There may be other optimizations regarding how to select the samplings for the hyperparameters in the models, such as Bayesian techniques, but the embodiments presented herein accelerate the testing of models by using GPUs with efficient modeling and data flows.

At operation 410, the best hyperparameters are output once the testing model converges to the optimal values. The hyperparameter sets with the best performance are selected and stored in memory for future use. The hyperparameter metrics used for selecting the best hyperparameter sets may include one or more of the Area under the ROC Curve (AUC), the Precision@K model, and the Recall.

With the AUC, a common metric for classification applications, the higher the values the better. A recommended threshold may be defined (e.g., 0.9 or above) for most applications. With the Precision@K, also, the higher the values the better, and a recommended threshold may be defined (e.g., 0.9). With the recall model, a common metric for retrieval applications, the higher the values the better, and the recommended threshold may be 0.9 or above for most applications.

Thus, at operation 410, the hyperparameters for the best model (or models), the hyperparameter distribution, and the logs of training and validation are reported.

FIG. 5 illustrates the model and the dataset for the machine-learning program, according to some example embodiments. In a simple embodiment, a plurality of linear regressions 502-504 are to be modeled. Each linear regression has a respective single tuning parameter λᵢ 506-508 that is to be evaluated utilizing a common dataset 510. In sonic models, there could be hundreds or thousands of linear regression models and these models are to be trained with the same dataset 510 for evaluation.

In some example embodiments, there could be hundreds of hyperparameters, and a computation graph is constructed. Hundreds of sub-models are packed together, where each sub-model corresponds to one hyperparameter configuration, and these sub-models are packed together to evaluate the same dataset 510.

In some example embodiments, the dataset includes a group of vectors. Each vector may hold a plurality of records (e.g., 1000), and each vector may have a large dimension (e.g., 100 or more). Therefore, the dataset may be very large.

For example, one dataset may refer to activities of users in a social network, such as interactions of the users with the social network feed. In some cases, the dataset may include ten thousand columns and fifteen million rows. Each element of the vector corresponds to a feature, such as a user clicking on “like” on a feed item. This dataset may be used to learn how users interact with the feed items. Thus, the dataset corresponds to a particular experiment where data is collected from the users, and the data is then used to train the machine-learning program. The goal is to analyze user behavior to determine the interests of the users and provide a feed with interesting elements for the user.

FIG. 6 is an architecture for searching hyperparameters, according to some example embodiments. Embodiments provide for the use of multiple GPU machines to speed up the model training. In the exemplary embodiment illustrated in FIG. 6, a computing device 602 includes four CPUs, but other embodiments may utilize from one to ten GPUs or more.

Each GPU 604 includes a plurality of cores 606 and a GPU memory 608. The GPU memory 608 may be used by the GPU 604 for local storage. In some example embodiments, the GPU memory 608 is used to store one or more dataset fragments and one or more models 611.

The dataset 510 is divided into fragments for processing because the dataset 510 is usually much bigger than the size of the GPU memory 608. Therefore, to evaluate each model, the model evaluates one dataset fragment at a time until the whole dataset 510 has been processed.

In the exemplary embodiment of FIG. 6, a dataset fragment A 610 is loaded into the GPU and then a plurality of cores evaluates the dataset fragment, where each core is used to evaluate a model 611 for a given hyperparameter value set. Further, although one model 611 is illustrated, other embodiments may include a plurality of models for evaluation of the dataset fragment.

While the dataset fragment A 610 is being evaluated, the next dataset fragment B 612 is loaded into the GPU, and when the GPU cores finished processing one dataset fragment, another dataset fragment is already available in memory to continue the evaluation. The process repeats by loading the next dataset while one dataset is being processed until the complete dataset is analyzed.

The computing device 602 further includes CPU 618, memory 614, and a plurality of programs 620 (which may reside in memory 614). The CPU 618 includes one or more cores 622 and a CPU memory 624. The CPU 618 is used to execute programs 620.

The memory 614 includes one or more models 616 for evaluation of the dataset 510, which may be downloaded from a dataset database 634 over network 114. The complete dataset model may be stored in the memory 614, or a portion of the dataset 510 may be stored at one point in time. In this case, as more data is needed for the analysis from the dataset, the data is downloaded from the database 634. The memory 614 and the database 634 may also keep logs from the testing as well as results from the model evaluation.

The programs 620 include a modeling manager 626, a user interface 628, a stream manager 630, and a communication manager 632. The modeling manager 626, also referred to herein as an arbiter, manages the activities of the GPUs for evaluating one or more models with a plurality of hyperparameter value sets. The modeling manager 626 coordinates the loading of the models into the GPUs as well as the dataset fragments. For example, the modeling manager 626 assigns a model and a hyperparameter value set to each of the cores being utilized.

The user interface 628 may be used to configure operations for testing of the different models, such as entering model parameters, setting up testing strategies, viewing results, and so forth.

The stream manager 630 manages the loading of dataset fragments into the GPU memories 608 and coordinates the flow of data. The stream manager 630 aims at having one dataset fragment ready to continue testing when the cores finish evaluation of the previous dataset fragment. The communications manager 632 manages the communication operations within the computing device 602 as well as communications via network 114.

The system allows for the testing of hyperparameter value sets in parallel, thereby making the evaluation process much faster. Also, by utilizing a large number of cores, the number of models evaluated in parallel is greatly increased. A key advantage of this architecture is that the same dataset fragment may be utilized for testing by a plurality of cores simultaneously, which greatly reduces the amount of time required to load the data. If each process would have its own copy of the dataset fragment in a respective memory, then much more memory would be required and the data would have to be loaded many more times.

In some example embodiments, there may be thousands of hyperparameter value sets to be tested, and several computing devices 602 operate as a cluster, where each computing device includes a plurality of GPUs. This way the processing parallelism may be further increased.

Another solution may have one hundred machines, with one or more CPUs, operating together to perform the modeling, but this is much less efficient than having computing devices with GPUs that greatly increase the number of cores available for processing as well as decreasing the amount of communications required to transmit the dataset to the different machines. One great advantage for speeding the process is the ability to share the dataset fragment information in the GPU by a plurality of cores, where each core is performing its own analysis of the dataset.

One of the advantages of GPUs is that they have 10 to 100 times more raw computing power than a single CPU, especially for floating-point operations. However, the drawback of the GPU is that the GPU needs to communicate to the main memory through a bus (e.g., PCI Express). The bus may be a bottleneck for data flow. If different models are placed in the GPU and each model performs its own independent analysis of the dataset, different cores would access different parts of the dataset at any given point in time. This means that there would be a high demand for the bus to transmit the data fragments to the GPU. However, by sharing the dataset among the different cores, the demands on the bus are greatly reduced, thus eliminating the bottleneck for data transmission.

In some example embodiments, the machine-learning program utilizes very shallow models, such as logistic regression models. In these cases, most of the computing resources are used for calculating the matrix inner product. If CPUs or cores are used independently for the testing, resources are wasted to calculate the inner product and it is not possible to even teed one CPU fast enough with data to perform the floating point operations.

In other cases, the machine-learning is used for image classification (e.g., image identification). In this case, there may be a large number of sparse vectors (e.g., with a large number of zero values), and the image is processed via a series of convolutions that may require thousands of inner products. Therefore, the use of GPU's in parallel may greatly accelerate the image recognition training.

The modeling manager 626 coordinates the operations of the different cores. For example, the modeling manager 626 may load the respective model and hyperparameter value set for each core and then invoke the stream manager 630 to start loading dataset fragments. Once the data is loaded into the GPU memory 608, the modeling manager 626 invokes the cores to perform the respective operations.

In another mode, GPU nodes can store different sets of models. After the data is streamed to the GPU memory 608, the evaluation may be performed on several hyperparameter value sets.

It is noted that some models may be complex and require large amounts of internal memory to hold the model and the required data. In this case, only a few of these complex models may be packed at one point within a GPU. For example, if the model requires a gigabyte of memory, then only five or six (depending on the GPU) models may be packed in a GPU. However, other models are simpler and may only require 10 kB of memory. In this case, hundreds of these simpler models may be packed into one GPU.

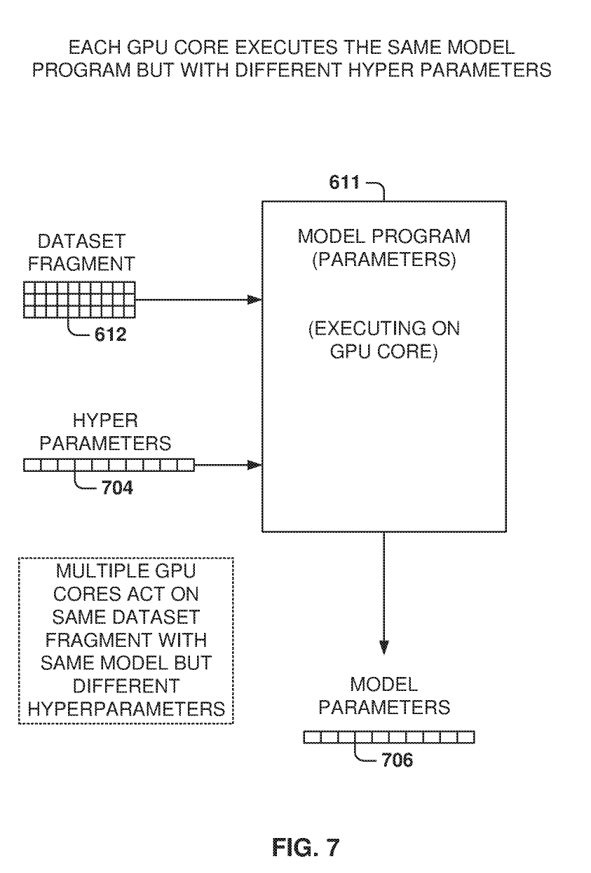

FIG. 7 illustrates the model program executing on a GPU core, according to some example embodiments. The model is instantiated as a model program 611, and in some example embodiments, the model program 611 executes on a GPU core.

The model program 611 has a set of inputs that include hyperparameter values 704, also referred to herein as a hyperparameter value set, and the dataset fragment 612. The output is the model parameters 706. The model program 611 also includes internal variables, so the model program 611 needs to consume memory, such as the GPU memory.

Once the model program 611 receives the inputs, then the model program is fully materialized and able to execute on a core. This is referred to as the realization of the model. Since the dataset is too large to consume at once by the model program 611, the dataset is broken in fragments and fed sequentially to the model program 611. For example, the dataset may be broken into hundreds or thousands of dataset fragments. For example, and without meaning to be limiting, a GPU memory may have a capacity of 12 GB and the dataset may be in the order of half a terabyte to a few terabytes.

As discussed earlier, to speed up the modeling process, there may be hundreds of realizations of the model executing in parallel, with each model having its own hyperparameters 704, and all the models consuming the same dataset fragment 612.

Some problems may utilize a single model, so searching for the optimal training may require analyzing the same model for a large number of different hyperparameter value sets. On the other hand, other problems may utilize a variety of models and the evaluation process requires evaluating the different models, also with different hyperparameter value sets.

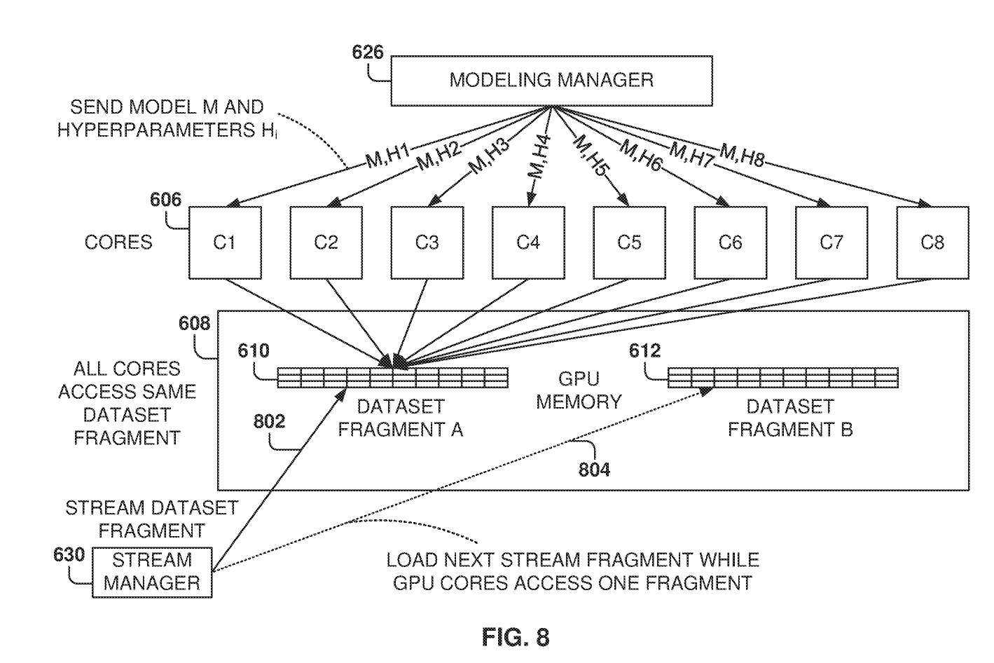

FIG. 8 illustrates the task distribution by the modeling manager, according to sonic example embodiments. FIG. 8 illustrates the process for configuring eight cores to operate in parallel to analyze a model with different hyperparameter value sets. In this case, alt the cores 606 instantiate the same model M, but other embodiments may have different cores acting on different models. However, the same design principles may be utilized for configurations with hundreds of cores.

The modeling manager 626 instantiates the cores 606 with the model M and the respective hyperparameter value set H₁. Thus, core C₁ receives hyperparameter value set H₁, C₂ receives H₂, and so forth. The modeling manager 626 also coordinates the loading of the dataset fragments 610, 612, in the GPU memory 608 via the stream manager 630. As discussed earlier, the stream manager 630 streams a dataset fragment 802, and the modeling manager 626 sends a command to the respective cores to start processing after the dataset fragment is available in GPU memory 608.

While the cores are processing one dataset fragment, the stream manager 630 streams 804 the next dataset fragment to the GPU memory. This way, when the cores finish processing one dataset fragment, the next dataset fragment is already available in memory for a quick start of the next processing cycle.

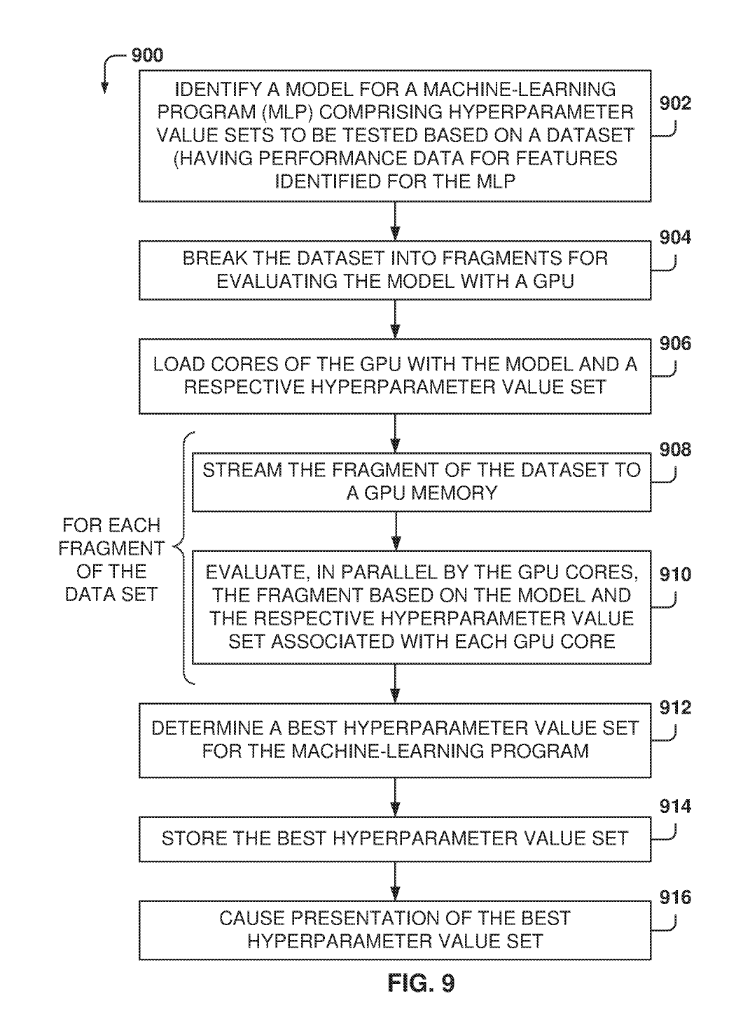

FIG. 9 is a flowchart of a method 900, according to some example embodiments, for searching a hyperparameter value set for training a machine-learning program. While the various operations in this flowchart are presented and described sequentially, one of ordinary skill will appreciate that sonic or all of the operations may be executed in a different order, be combined or omitted, or be executed in parallel.

At operation 902, a model for a machine-learning program (MLP) is identified. The model comprises a plurality of hyperparameter value sets to be tested based on a dataset, and the dataset has performance data for a plurality of features identified for the machine-learning program.

From operation 902, the method flows to operation 904 for breaking the dataset into a plurality of fragments for evaluating the model with a GPU. From operation 904, the method flows to operation 906, where a plurality of cores of the GPU are loaded with the model and a respective hyperparameter value set.

For each fragment from the plurality of fragments of the dataset, operations 908 and 910 are performed. At operation 908, the fragment of the dataset is streamed to a GPU memory, and at operation 910, the plurality of cores of the GPU evaluate, in parallel, the fragment of the dataset based on the model and the respective hyperparameter value set associated with each core of the GPU.

At operation 912, the best hyperparameter value set is determined for the machine-learning program. Further, at operation 914, the best hyperparameter value set is stored in the memory, and, at operation 916, the best hyperparameter value set is presented.

In one example, streaming the fragment further includes: transmitting a first fragment to the GPU memory; while the first fragment is being evaluated, transmitting a second fragment to the GPU memory; and, after the first fragment has been evaluated, transmitting a third fragment to the GPU memory while the second fragment is being evaluated.

In one example, breaking the dataset into the plurality of fragments further comprises identifying a fragment size and breaking the dataset into fragments with a size up to the fragment size.

In one example, the method 900 further comprises generating the plurality of hyperparameter value sets based on one or more of user-specified hyperparameters, a uniform distribution of hyperparameters, a nonparametric distribution of hyperparameters, a prior distribution of hyperparameters, a distribution based on Bayesian rules and experimental results, and a distribution modeled by a Gaussian process.

In one example, each hyperparameter value set includes one or more of a number of hidden layers in the machine-learning program, a number of hidden nodes in each layer, a learning rate for one or more adaptation schemes, a regularization parameter, types of nonlinearities, and use of dropout.

In another example, determining the best hyperparameter value set further comprises testing the corresponding machine-learning program for each hyperparameter value set and selecting the hyperparameter value set that is a better predictor.

In one example, the GPU is in a computing device having a memory and a processor, wherein an arbiter executing on the processor coordinates the streaming of fragments and loading of models in the cores of the GPU.

In one example, the dataset includes data corresponding to interactions of users performed in a context of a social network.

In one example, loading the plurality of cores of the GPU further comprises transferring a model program to the GPU memory and invoking the model program with the corresponding hyperparameter value set at each of the cores of the GPU.

In one example, the method 900 further comprises utilizing the machine program trained with the best hyperparameter parameter value set for making predictions associated with new input data.

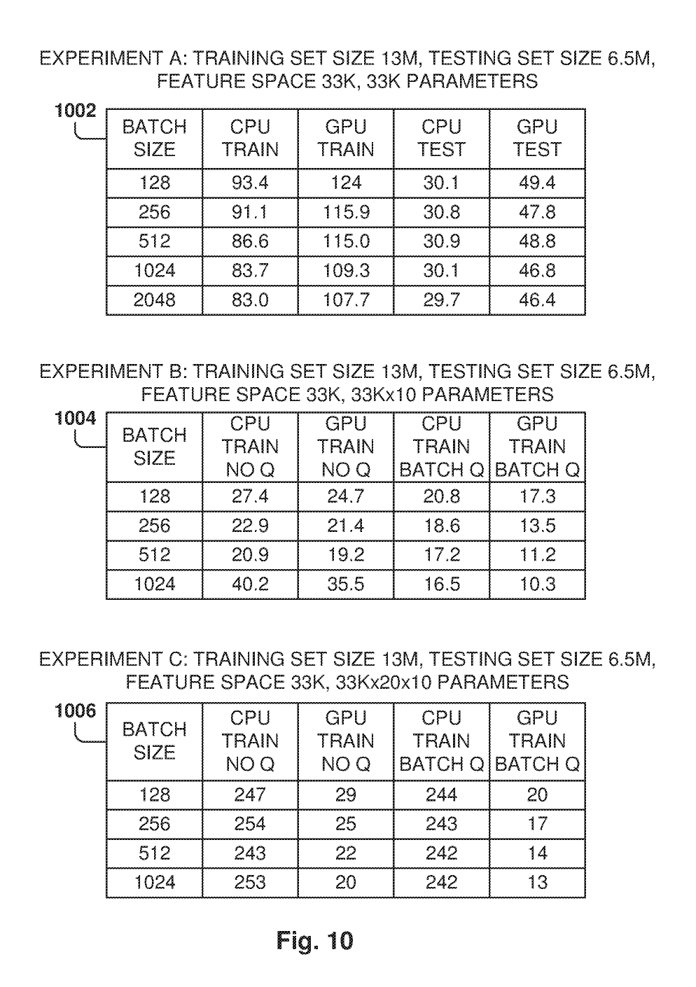

FIG. 10 shows some example embodiments of test experiments. Some experiments, considered illustrative and not meant to be limiting, were performed to check the performance of a neural network with reference to multiple hyperparameters, such as number of layers, number of hidden nodes, batch size, learning rate, and regularization parameter. Data regarding interactions of users with a social network was utilized as the dataset. Experiments were performed to compare the performance when using one or more CPUs vs using a GPU.

Experiment 1002 illustrates the time cost of training and testing one model with 33K parameters using one CPU with 2 cores or using one GPU. Each column shows the time cost for different batch sizes. For example, the training time of using the CPU with a batch size of 128 is 93.4 minutes. In this simple model, it can be observed than using one CPU is actually more efficient with regards to time cost.

Experiment 1004 shows the time cost of training 10 models (each with 33K parameters) using one CPU with 2 cores and one GPU. In this case, two techniques were used for feeding the data: with an input queue and without the input queue. For example, the training time with 1M records with batch size 128 and CPU and with batch queue enabled is 20.8 minutes. It can be observed that using the GPU is more efficient in terms of time cost, and using batch queues can improve efficiency for both CPU and GPU scenarios.

Experiment 1006 illustrates the time cost of training 10 models (each with 33K*20=660K parameters) using one CPU with 2 cores or one GPU. In this case, two techniques were used for feeding the data: with an input queue and without the input queue. For example, the training time, with 1M records, batch size of 128, and with the batch queue enabled, for the CPU is 244 minutes and 20 minutes for the GPU. In this case, using the GPU is significantly more efficient in terms of time cost. Further, using the batch queue may improve the efficiency of both CPU and GPU systems.

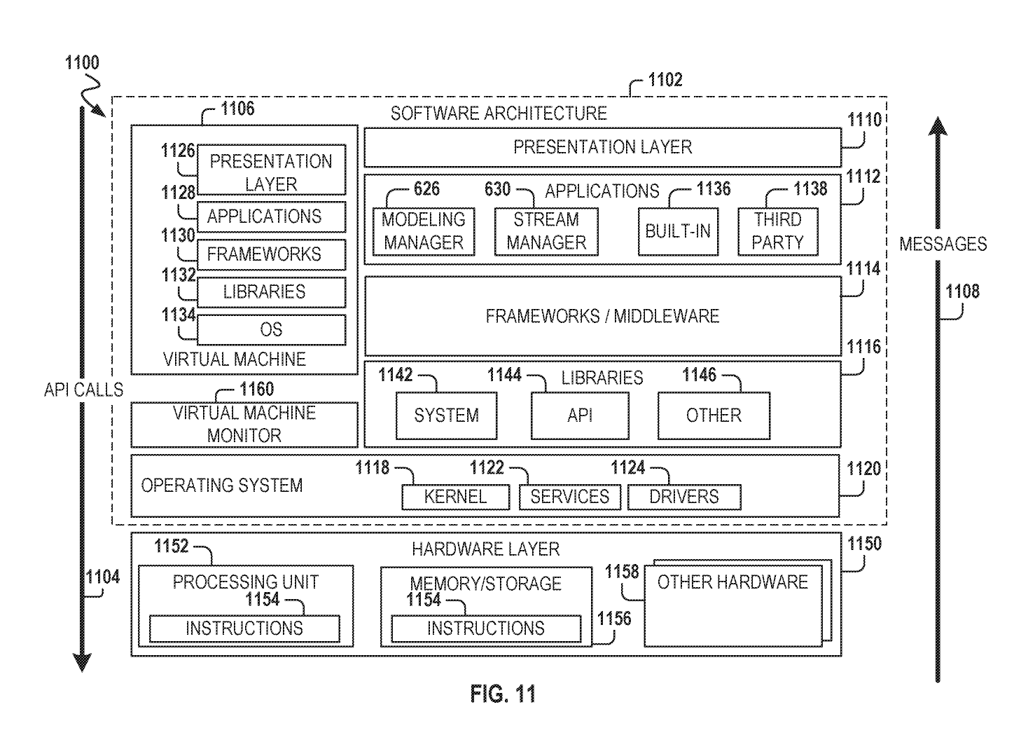

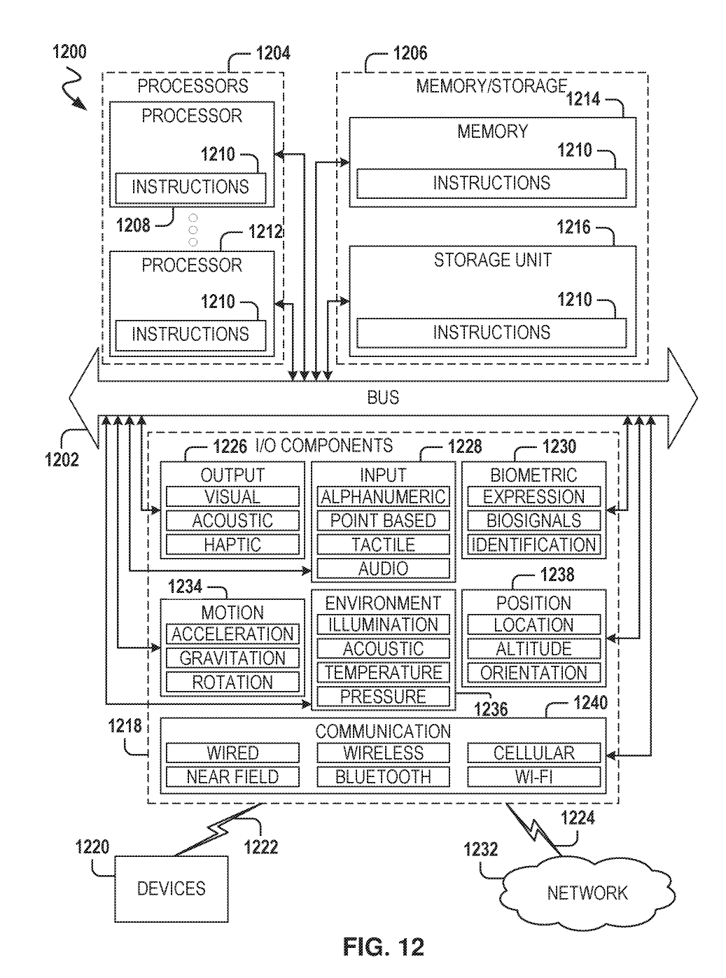

FIG. 11 is a block diagram 1100 illustrating a representative software architecture 1102, which may be used in conjunction with various hardware architectures herein described. FIG. 11 is merely a non-limiting example of a software architecture 1102, and it will be appreciated that many other architectures may be implemented to facilitate the functionality described herein. The software architecture 1102 may be executing on hardware such as a machine 1200 of FIG. 12 that includes, among other things, processors 1204, memory/storage 1206, and input/output (I/O) components 1218. A representative hardware layer 1150 is illustrated and may represent, for example, the machine 1200 of FIG. 12. The representative hardware layer 1150 comprises one or more processing units 1152 having associated executable instructions 1154. The executable instructions 1154 represent the executable instructions of the software architecture 1102, including implementation of the methods, modules, and so forth of FIGS. 1-10. The hardware layer 1150 also includes memory and/or storage modules 1156, which also have the executable instructions 1154. The hardware layer 1150 may also comprise other hardware 1158, which represents any other hardware of the hardware layer 1150, such as the other hardware illustrated as part of the machine 1200.

In the example architecture of FIG. 11, the software architecture 1102 may be conceptualized as a stack of layers where each layer provides particular functionality. For example, the software architecture 1102 may include layers such as an operating system 1120, libraries 1116, frameworks/middleware 1114, applications 1112, and a presentation layer 1110. Operationally, the applications 1112 and/or other components within the layers may invoke API calls 1104 through the software stack and receive a response, returned values, and so forth illustrated as messages 1108 in response to the API calls 1104. The layers illustrated are representative in nature, and not all software architectures have all layers. For example, sonic mobile or special-purpose operating systems may not provide a frameworks/middleware 1114 layer, while others may provide such a layer. Other software architectures may include additional or different layers.

The operating system 1120 may manage hardware resources and provide common services. The operating system 1120 may include, for example, a kernel 1118, services 1122, and drivers 1124. The kernel 1118 may act as an abstraction layer between the hardware and the other software layers. For example, the kernel 1118 may be responsible for memory management, processor management (e.g., scheduling), component management, networking, security settings, and so on. The services 1122 may provide other common services for the other software layers. The drivers 1124 may be responsible for controlling or interfacing with the underlying hardware. For instance, the drivers 1124 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1116 may provide a common infrastructure that may be utilized by the applications 1112 and/or other components and/or layers. The libraries 1116 typically provide functionality that allows other software modules to perform tasks in an easier fashion than by interfacing directly with the underlying operating system 1120 functionality (e.g., kernel 1118, services 1122, and/or drivers 1124). The libraries 1116 may include system libraries 1142 (e.g., C standard library) that may provide functions such as memory allocation functions, string manipulation functions, mathematic functions, and the like. In addition, the libraries 1116 may include API libraries 1144 such as media libraries (e.g., libraries to support presentation and manipulation of various media formats such as MPEG4, MP3, AAC, AMR, JPG, PNG), graphics libraries (e.g., an OpenGL framework that may be used to render two-dimensional (2D) and three-dimensional (3D) graphic content on a display), database libraries (e.g., SQLite that may provide various relational database functions), web libraries (e.g., WebKit that may provide web browsing functionality), and the like. The libraries 1116 may also include a wide variety of other libraries 1146 to provide many other APIs to the applications 1112 and other software components/modules.

The frameworks 1114 (also sometimes referred to as middleware) may provide a higher-level common infrastructure that may be utilized by the applications 1112 and/or other software components/modules. For example, the frameworks 1114 may provide various graphic user interface (GUI) functions, high-level resource management, high-level location services, and so forth. The frameworks 1114 may provide a broad spectrum of other APIs that may be utilized by the applications 1112 and/or other software components/modules, some of which may be specific to a particular operating system or platform.

The applications 1112 include the modeling manager 626, the stream manager 630, other modules as shown in FIG. 6 (not shown), built-in applications 1136, and third-party applications 1138. Examples of representative built-in applications 1136 may include, but are not limited to, a contacts application, a browser application, a book reader application, a location application, a media application, a messaging application, and/or a game application. The third-party applications 1138 may include any of the built-in applications 1136 as well as a broad assortment of other applications. In a specific example, the third-party application 1138 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1138 may invoke the API calls 1104 provided by the mobile operating system such as the operating system 1120 to facilitate functionality described herein.

The applications 1112 may utilize built-in operating system functions (e.g., kernel 1118, services 1122, and/or drivers 1124), libraries (e.g., system libraries 1142, API libraries 1144, and other libraries 1146), or frameworks/middleware 1114 to create user interfaces to interact with users of the system. Alternatively, or additionally, in some systems, interactions with a user may occur through a presentation layer, such as the presentation layer 1110. In these systems, the application/module “logic” may be separated from the aspects of the application/module that interact with a user.

Some software architectures utilize virtual machines. In the example of FIG. 11, this is illustrated by a virtual machine 1106. A virtual machine creates a software environment where applications/modules may execute as if they were executing on a hardware machine (such as the machine 1200 of FIG. 12, for example). The virtual machine 1106 is hosted by a host operating system (e.g., the operating system 1120 in FIG. 11) and typically, although not always, has a virtual machine monitor 1160, which manages the operation of the virtual machine 1106 as well as the interface with the host operating system (e.g., the operating system 1120). A software architecture executes within the virtual machine 1106 such as an operating system 1134, libraries 1132, frameworks/middleware 1130, applications 1128, and/or a presentation layer 1126. These layers of software architecture executing within the virtual machine 1106 may be the same as corresponding layers previously described or may be different.

FIG. 12 is a block diagram illustrating components of a machine 1200, according to some example embodiments, able to read instructions from a machine-readable medium (e.g., a machine-readable storage medium) and perform any one or more of the methodologies discussed herein. Specifically, FIG. 12 shows a diagrammatic representation of the machine 1200 in the example form of a computer system, within which instructions 1210 (e.g., software, a program, an application, an applet, an app, or other executable code) for causing the machine 1200 to perform any one or more of the methodologies discussed herein may be executed. For example, the instructions 1210 may cause the machine 1200 to execute the flow diagrams of FIGS. 3, 4, and 9. Additionally, or alternatively, the instructions 1210 may implement the programs 620 of computing device 602 of FIG. 6, and so forth. The instructions 1210 transform the general, non-programmed machine 1200 into a particular machine 1200 programmed to carry out the described and illustrated functions in the manner described.

In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a switch, a controller, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1210, sequentially or otherwise, that specify actions to be taken by the machine 1200. Further, while only a single machine 1200 is illustrated, the term “machine” shall also be taken to include a collection of machines 1200 that individually or jointly execute the instructions 1210 to perform any one or more of the methodologies discussed herein.

The machine 1200 may include processors 1204, memory/storage 1206, and I/O components 1218, which may be configured to communicate with each other such as via a bus 1202. In an example embodiment, the processors 1204 (e.g., a CPU, a Reduced Instruction Set Computing (RISC) processor, a Complex Instruction Set Computing (CISC) processor, a GPU, a Digital Signal Processor (DSP), an Application-Specific integrated Circuit (ASIC), a Radio-Frequency Integrated Circuit (RFIC), another processor, or any suitable combination thereof) may include, for example, a processor 1208 and a processor 1212 that may execute the instructions 1210. The term “processor” is intended to include multi-core processors that may comprise two or more independent processors (sometimes referred to as “cores”) that may execute instructions contemporaneously. Although FIG. 12 shows multiple processors 1204, the machine 1200 may include a single processor with a single core, a single processor with multiple cores (e.g., a multi-core processor), multiple processors with a single core, multiple processors with multiple cores, or any combination thereof.

The memory/storage 1206 may include a memory 1214, such as a main memory, or other memory storage, and a storage unit 1216, both accessible to the processors 1204 such as via the bus 1202. The storage unit 1216 and memory 1214 store the instructions 1210 embodying any one or more of the methodologies or functions described herein. The instructions 1210 may also reside, completely or partially, within the memory 1214, within the storage unit 1216, within at least one of the processors 1204 (e.g., within the processor's cache memory), or any suitable combination thereof, during execution thereof by the machine 1200. Accordingly, the memory 1214, the storage unit 1216, and the memory of the processors 1204 are examples of machine-readable media.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EPROM)), and/or any suitable combination thereof. The term “machine-readable medium” should be taken to include a single medium or multiple media (e.g., a centralized or distributed database, or associated caches and servers) able to store the instructions 1210. The term “machine-readable medium” shall also be taken to include any medium, or combination of multiple media, that is capable of storing instructions (e.g., instructions 1210) for execution by a machine (e.g., machine 1200), such that the instructions, when executed by one or more processors of the machine (e.g., processors 1204), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1218 may include a wide variety of components to receive input, provide output, produce output, transmit information, exchange information, capture measurements, and so on. The specific I/O components 1218 that are included in a particular machine will depend on the type of machine. For example, portable machines such as mobile phones will likely include a touch input device or other such input mechanisms, while a headless server machine will likely not include such a touch input device. It will be appreciated that the I/O components 1218 may include many other components that are not shown in FIG. 12. The I/O components 1218 are grouped according to functionality merely for simplifying the following discussion, and the grouping is in no way limiting. In various example embodiments, the I/O components 1218 may include output components 1226 and input components 1228. The output components 1226 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1228 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1218 may include biometric components 1230, motion components 1234, environmental components 1236, or position components 1238 among a wide array of other components. For example, the biometric components 1230 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1234 may include acceleration sensor components (e.g., accelerometer), gravitation sensor components, rotation sensor components (e.g., gyroscope), and so forth. The environmental components 1236 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1238 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1218 may include communication components 1240 operable to couple the machine 1200 to a network 1232 or devices 1220 via a coupling 1224 and a coupling 1222, respectively. For example, the communication components 1240 may include a network interface component or other suitable device to interface with the network 1232. In further examples, the communication components 1240 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1220 may be another machine or any of a wide variety of peripheral devices (e.g., a peripheral device coupled via a USB).

Moreover, the communication components 1240 may detect identifiers or include components operable to detect identifiers. For example, the communication components 1240 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1240, such as location via. Internet Protocol (IP) geo-location, location via Wi-Fi® signal triangulation, location via detecting an NFC beacon signal that may indicate a particular location, and so forth.

In various example embodiments, one or more portions of the network 1232 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1232 or a portion of the network 1232 may include a wireless or cellular network and the coupling 1224 may be a Code Division Multiple Access (CDMA) connection, a Global System for Mobile communications (GSM) connection, or another type of cellular or wireless coupling. In this example, the coupling 1224 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 1210 may be transmitted or received over the network 1232 using a transmission medium via a network interface device (e.g., a network interface component included in the communication components 1240) and utilizing any one of a number of well-known transfer protocols (e.g., hypertext transfer protocol (HTTP)). Similarly, the instructions 1210 may be transmitted or received using a transmission medium via the coupling 1222 (e.g., a peer-to-peer coupling) to the devices 1220. The term “transmission medium” shall be taken to include any intangible medium that is capable of storing, encoding, or carrying the instructions 1210 for execution by the machine 1200, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
identifying a model for a machine-learning program, the model comprising a plurality of hyperparameter value sets to be tested based on a dataset, the dataset having performance data for a plurality of features identified for the machine-learning program;
breaking the dataset into a plurality of fragments for evaluating the model with a graphics processing unit (GPU);
loading a plurality of cores of the GPU with the model and a respective hyperparameter value set;
for each fragment from the plurality of fragments of the dataset:
streaming the fragment of the dataset to a GPU memory; and
evaluating, in parallel by the plurality of cores of the GPU, the fragment of the dataset based on the model and the respective hyperparameter value set associated with each core of the GPU;
determining a best hyperparameter value set, from the plurality of hyperparameter value sets, for the machine-learning program; and
storing and causing presentation of the best hyperparameter value set.

2. The method as recited in claim 1, wherein streaming the fragment further includes:
transmitting a first fragment to the GPU memory;
while the first fragment is being evaluated, transmitting a second fragment to the GPU memory; and
after the first fragment has been evaluated, transmitting a third fragment to the GPU memory while the second fragment is being evaluated.

3. The method as recited in claim 1, wherein breaking the dataset into plurality of fragments further comprises:
identifying a fragment size; and
breaking the dataset into fragments with a size up to the fragment size.

4. The method as recited in claim 1, further comprising:
generating the plurality of hyperparameter value sets based on one or more of user-specified hyperparameters, a uniform distribution of hyperparameters, a nonparametric distribution of hyperpararmeters, a prior distribution of hyperparameters, a distribution based on Bayesian rules and experimental results, and a distribution modeled by a Gaussian process.

5. The method as recited in claim 1, wherein each hyperparameter value set includes one or more of a number of hidden layers in the machine-learning program, a number of hidden nodes in each layer, a learning rate for one or more adaptation schemes, a regularization parameter, types of nonlinear activation functions, and use of dropout.

6. The method as recited in claim 1, wherein determining the best hyperparameter value set further comprises:
testing the corresponding machine-learning program for each hyperparameter value set; and
selecting the hyperparameter value set that is the best predictor.

7. The method as recited in claim 1, wherein the GPU is in a computing device having a memory and a processor, wherein an arbiter executing on the processor coordinates the streaming of fragments and loading of models in the cores of the GPU.

8. The method as recited in claim 1, wherein the dataset includes data corresponding to interactions of users performed in a context of a social network.

9. The method as recited in claim 1, wherein loading the plurality of cores of the GPU further comprises:
transferring a model program to the GPU memory; and
invoking the model program with the corresponding hyperparameter value set at each of the cores of the GPU.

10. The method as recited in claim 1, further comprising:
utilizing the machine program trained with the best hyperparameter parameter value set for making predictions associated with new input data.

11. A system comprising:
a memory comprising instructions;
a graphics processing unit (GPU) having a plurality of GPU cores and a GPU memory; and
one or more computer processors, wherein the instructions, when executed by the one or more computer processors, cause the one or more computer processors to perform operations comprising:
identifying a model for a machine-learning program, the model comprising a plurality of hyperparameter value sets to be tested based on a dataset, the dataset having performance data for a plurality of features identified for the machine-learning program;
breaking the dataset into a plurality of fragments for evaluating the model with the GPU;
loading the plurality of cores of the GPU with the model and a respective hyperparameter value set;
for each fragment from the plurality of fragments of the dataset, streaming the fragment of the dataset to the GPU memory, wherein the plurality of cores of the GPU evaluate, in parallel, the fragment of the dataset based on the model and the respective hyperparameter value set associated with each core of the GPU;
determining a best hyperparameter value set, from the plurality of hyperparameter value sets, for the machine-learning program; and
storing and causing presentation of the best hyperparameter value set.

12. The systemas recited in claim 11, wherein streaming the fragment further includes:
transmitting a first fragment to the GPU memory;
while the first fragment is being evaluated, transmitting a second fragment to the GPU memory; and
after the first fragment has been evaluated, transmitting a third fragment to the GPU memory while the second fragment is being evaluated.

13. The system as recited in claim 11, wherein breaking the dataset into the plurality of fragments further comprises:
identifying a fragment size; and
breaking the dataset into fragments with a size up to the fragment size.

14. The system as recited in claim 11, wherein the instructions further cause the one or more computer processors to perform operations comprising:
generating the plurality of hyperparameter value sets based on one or more of user-specified hyperparameters, a uniform distribution of hyperparameters, a nonparametric distribution of hyperparameters, a prior distribution of hyperparameters, a distribution based on Bayesian rules and experimental results, and a distribution modeled by a Gaussian process.

15. The system as recited in claim 11, wherein each hyperparameter value set includes one or more of a number of hidden layers in the machine-learning program, a number of hidden nodes in each layer, a learning rate for one or more adaptation schemes, a regularization parameter, types of nonlinearities, and use of dropout.

16. A non-transitory machine-readable storage medium including instructions that, when executed by a machine, cause the machine to perform operations comprising:
identifying a model for a machine-learning program, the model comprising a plurality of hyperparameter value sets to be tested based on a dataset, the dataset having performance data for a plurality of features identified for the machine-learning program;
breaking the dataset into a plurality of fragments for evaluating the model with a graphics processing unit (GPU);
loading a plurality of cores of the GPU with the model and a respective hyperparameter value set;
for each fragment from the plurality of fragments of the dataset:
streaming the fragment of the dataset to a GPU memory; and
evaluating, in parallel by the plurality of cores of the GPU, the fragment of the dataset based on the model and the respective hyperparameter value set associated with each core of the GPU;
determining a best hyperparameter value set, from the plurality of hyperparameter value sets, for the machine-learning program; and
storing and causing presentation of the best hyperparameter value set.

17. The machine-readable storage medium as recited in claim 16, wherein streaming the fragment further includes:
transmitting a first fragment to the GPU memory;
while the first fragment is being evaluated, transmitting a second fragment to the GPU memory; and
after the first fragment has been evaluated, transmitting a third fragment to the GPU memory while the second fragment is being evaluated.

18. The machine-readable storage medium as recited in claim 16, wherein breaking the dataset into the plurality of fragments further comprises:
identifying a fragment size; and
breaking the dataset into fragments with a size up to the fragment size.

19. The machine-readable storage medium as recited in claim 16, wherein the machine further performs operations comprising:
generating the plurality of hyperparameter value sets based on one or more of user-specified hyperparameters, a uniform distribution of hyperparameters, a nonparametric distribution of hyperparameters, a prior distribution of hyperparameters, a distribution based on Bayesian rules and experimental results, and a distribution modeled by a Gaussian process.

20. The machine-readable storage medium as recited in claim 16, wherein each hyperparameter value set includes one or more of a number of hidden layers in the machine-learning program, a number of hidden nodes in each layer, a learning rate for one or more adaptation schemes, a regularization parameter, types of nonlinearities, and use of dropout.
